(19) United States
(12) Patent Application Publication
(10) Pub. No.: US 2014/0174737 A1
(43) Pub. Date: Jun. 26, 2014

(54) Wellbore Servicing Materials and Methods of Making and Using Same

(71) Applicant: HALLIBURTON ENERGY SERVICES, INC., Houston, TX (US)

(72) Inventors: B. Raghava REDDY, The Woodlands, TX (US); Janette CORTEZ, Kingwood, TX (US)

(73) Assignee: HALLIBURTON ENERGY SERVICES, INC., Houston, TX (US)

(21) Appl. No.: 13/724,688

(22) Filed: Dec. 21, 2012

(51) Int. Cl. E21B 43/26; C09K 8/42

(52) U.S. Cl. CPC E21B 43/261; C09K 8/426
USPC 166/281; 166/307; 507/231

(57) ABSTRACT

A method of servicing a wellbore in a subterranean formation comprising placing a first wellbore servicing fluid comprising a diverter material into a wellbore, allowing the diverter material to form a diverter plug at a first location in the wellbore or subterranean formation, diverting the flow of a second wellbore servicing fluid to a second location in the wellbore or subterranean formation, and contacting the diverter plug with a third wellbore servicing fluid comprising a degradation accelerator and a phase transfer catalyst under conditions sufficient to form one or more degradation products. A method comprising contacting a diverter material with a phase transfer catalyst under conditions suitable to produce a composite material placing downhole a first wellbore servicing fluid comprising the composite material, and placing downhole a second wellbore servicing fluid comprising a degradation accelerator.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field

This disclosure relates to methods of servicing a wellbore. More specifically, it relates to servicing a wellbore with degradable polymers and degradation accelerators.

2. Background

Natural resources (e.g., oil or gas) residing in the subterranean formation may be recovered by driving resources from the formation into a wellbore using, for example, a pressure gradient that exists between the formation and the wellbore, the force of gravity, displacement of the resources from the formation using a pump or the force of another fluid injected into the well or an adjacent well. The production of fluid in the formation may be increased by hydraulically fracturing the formation. That is, a viscous fracturing fluid may be pumped down the wellbore at a rate and a pressure sufficient to form fractures that extend into the formation, providing additional pathways through which the oil or gas can flow to the well.

Unfortunately, water rather than oil or gas may eventually be produced by the formation through the fractures therein. To provide for the production of more oil or gas, a fracturing fluid may again be pumped into the formation to form additional fractures therein. However, the previously used fractures first must be plugged to prevent the loss of the fracturing fluid into the formation via those fractures. Additionally or alternatively, multiple zones may be fractured during a given operation, and one or more existing fracture zones may need to be temporarily plugged to divert fracturing fluid from one zone to another. In some instances, some fractures, natural or induced, may take in most of the proppant used in propping the created fracture open leaving less than an optimum amount of proppant for other fractures. A proppant diversion technique would enable even distribution of the proppant into all the fractures thereby increasing the exposed fracture area to hydrocarbon flow. Diversion of fracturing fluids in shale zones during the fracturing process is also helpful in increasing the complexity of fracture geometry by branching of the fractures in multiple directions thereby exposing a greater portion of the geological formation to fluid flow.

Diversion of fluids is also important in removing near wellbore damage to formation permeability due to a variety of reasons, for example scale deposition, hydrocarbon deposition and the like. The cleanup fluids used in removing such damage include acidic fluids or surfactant-based fluids. In order to evenly disperse the cleanup fluids over the entire damaged area, diverting agents may be used to divert the treatment fluids to undertreated zones.

Diverting materials are typically introduced into the wellbore and surrounding formation during fracturing and completion operations in order to provide a temporary plug for already fractured zones or a fracture branching point while fracturing. While the diverter plugs are in effect, the formation may be fractured again. However, upon finalization of the fracturing operations, the diverting materials may need to be removed in a timely manner at the discretion of the user to restore the flow of fluid (e.g., oil or gas) for collection. Thus an ongoing need exists for improved diverting materials and methods of utilizing same.

### SUMMARY

Disclosed herein is a method of servicing a wellbore in a subterranean formation comprising placing a first wellbore servicing fluid comprising a diverter material into a wellbore; allowing the diverter material to form a diverter plug at a first location in the wellbore or subterranean formation; diverting the flow of a second wellbore servicing fluid to a second location in the wellbore or subterranean formation; and contacting the diverter plug with a third wellbore servicing fluid comprising a degradation accelerator and a phase transfer catalyst under conditions sufficient to form one or more degradation products.

Also disclosed herein is a method comprising contacting a diverter material with a phase transfer catalyst under conditions suitable to produce a composite material; placing downhole a first wellbore servicing fluid comprising the composite material; and placing downhome a second wellbore servicing fluid comprising a degradation accelerator.

Also disclosed herein is a wellbore servicing fluid system comprising a first wellbore servicing fluid comprising a diverter material, wherein the diverter material comprises recycled polyethyleterephthalate; and a second wellbore servicing fluid comprising a degradation accelerator and a phase transfer catalyst, wherein the degradation accelerator comprises sodium hydroxide.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 displays polylactic acid degradation in the presence of various phase transfer catalysts.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

Disclosed herein are wellbore servicing fluids or compositions and methods of using same. In an embodiment, a method of servicing a wellbore comprises placing into the wellbore a wellbore servicing fluid (e.g., a first wellbore servicing fluid) comprising one or more diverting materials (DM). Subsequent to or concurrent with the DM being placed and performing its intended function, a wellbore servicing fluid (e.g., a subsequent wellbore servicing fluid) comprising a degradation accelerator (DA) and a phase transfer catalyst (PTC), collectively referred to herein as DA/PTC or a DA/PTC combination, may be introduced to the wellbore and brought into contact with the DM. Utilization of a wellbore servicing fluid comprising a DA/PTC in the methods disclosed herein may advantageously facilitate removal of a DM from a fluid flow path.

In an embodiment, the DM comprises any solid material comprising ester functionalities suitable for distribution within or into a flowpath (e.g., a subterranean flowpath within a wellbore and/or surrounding formation), for example, so as to form a pack, a bridge, a plug or a filter cake and thereby obstruct fluid movement via that flowpath. In an embodiment, the DM is configured to reduce the fluid flow via a given flowpath (i.e., reduce the fluid permeability of a point of entry for fluids into the formation) such that fluid movement is diverted (e.g., redirected) to another flowpath within the wellbore and/or surrounding formation.

In an embodiment, the DM comprising ester functionalities is comprised of a naturally-occurring material. Alternatively, the DM comprises a synthetic material. Alternatively, the DM comprises a mixture of a naturally-occurring and synthetic material.

In an embodiment, the DM comprises a degradable material comprising ester functionalities that may undergo irreversible degradation downhole. As used herein “degradation” refers to the separation of the material into simpler compounds that do not retain all the characteristics of the starting material. The terms “degradation” or “degradable” may refer to either or both of heterogeneous degradation (or bulk erosion) and/or homogeneous degradation (or surface erosion), and/or to any stage of degradation in between these two. Not intending to be bound by theory, degradation may be a result of, inter alia, an external stimuli (e.g., heat, temperature, pH, etc.). As used herein, the term “irreversible” means that the degradable material, once degraded downhole, should not reconstitute, reform or reconsolidate while downhole.

In an embodiment the DM comprises a degradable polymer. Herein the disclosure may refer to a polymer and/or a polymeric material. It is to be understood that the terms polymer and/or polymeric material herein are used interchangeably and are meant to each refer to compositions comprising at least one polymerized monomer in the presence or absence of other additives traditionally included in such materials. Examples of degradable polymers suitable for use as the DM include, but are not limited to homopolymers, random, block, graft, star- and hyper-branched polyesters, copolymers thereof, derivatives thereof, or combinations thereof. The term “derivative” is defined herein to include any compound that is made from one or more of the diverting materials, for example, by replacing one atom in the diverting material with another atom or group of atoms, rearranging two or more atoms in the diverting material, ionizing one of the diverting materials, or creating a salt of one of the diverting materials. The term “copolymer” as used herein is not limited to the combination of two polymers, but includes any combination of any number of polymers, e.g., graft polymers, terpolymers and the like.

In an embodiment, the degradable polymer comprises aliphatic polyesters; aromatic polyesters; poly(lactides); poly(glycolides); polycaprolactone, polyethyleneterephthalates; polybutyleneterephthalates; polyethylenenaphthalenates, copolymers, blends, derivatives, or combinations thereof. In an embodiment, the degradable polymer comprises a polymer based on p-terephthalic acid, m-terephthalic acid, o-terephthalic acid, their derivatives, or combinations thereof.

In an embodiment, the degradable polymer comprises solid cyclic dimers, monomers of solid organic hydroxy carboxylic acids or the lactones, or combinations of organic dicarboxylic acids and diols. Alternatively, the degradable polymer comprises substituted or unsubstituted lactides, glycolides, caprolactone, polylactic acid (PLA), polyglycolic acid (PGA), copolymers of lactic acid and glycolic acids, copolymers of glycolic acid with other hydroxy, carboxylic acid, or hydroxycarboxylic acid-containing moieties, copolymers of lactic acid with other hydroxy carboxylic acids-, or hydroxycarboxylic acid-containing moieties, or combinations thereof.

In an embodiment, the degradable polymer comprises an aliphatic polyester containing ester functionalities in the polymer backbone which may be represented by the general formula of repeating units shown in Formula I:

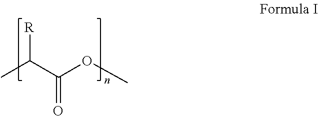

where n is an integer ranging from about 75 to about 10,000, alternatively from about 500 to about 5000, or alternatively from about 1000 to about 3000, and R comprises hydrogen, an alkyl group, an aryl group, an alkylaryl group, an acetyl group, heteroatoms, or combinations thereof.

In an embodiment, the aliphatic polyester comprises poly(lactic acid) or polylactide (PLA). Because both lactic acid and lactide can achieve the same repeating unit, the general term poly(lactic acid), as used herein, refers to Formula I (where R═CH₃) without any limitation as to how the polymer was formed (e.g., from lactides, lactic acid, or oligomers) and without reference to the degree of polymerization or level of plasticization.

Also, as will be understood by one of ordinary skill in the art, the lactide monomer may exist, generally, in one of three different forms: two stereoisomers L- and D-lactide and racemic D,L-lactide (meso-lactide). The oligomers of lactic acid, and oligomers of lactide suitable for use in the present disclosure may be represented by general Formula II:

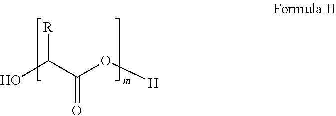

where m is an integer 2<m<75, alternatively, m is an integer and 2<m<10. In an embodiment, the molecular weight of the PLA may be less than about 5,400 g/mole, alternatively, less than about 720 g/mole, respectively. The stereoisomers of lactic acid may be used individually or combined to be used in accordance with the present disclosure.

In an additional embodiment, the degradable polymer comprises a copolymer of lactic acid. A copolymer of lactic acid may be formed by copolymerizing one or more stereoisomers of lactic acid with, for example, glycolide, ε-caprolactone, 1,5-dioxepan-2-one, or trimethylene carbonate, so as to obtain polymers with different physical and/or mechanical properties that are also suitable for use in the present disclosure.

In an embodiment, degradable polymers suitable for use in the present disclosure are formed by melt blending, physical blending, copolymerizing or otherwise mixing the stereoisomers of lactic acid. Alternatively, degradable polymers suitable for use in the present disclosure are formed by melt blending, physical blending, copolymerizing or otherwise mixing high and/or low molecular weight polylactides. Alternatively, degradable polymers suitable for use in the present disclosure are formed by melt blending, physical blending, copolymerizing or otherwise mixing polylactide with other polyesters. In an embodiment, the degradable polymer comprises PLA which may be synthesized using any suitable methodology. For example, PLA may be synthesized either from lactic acid by a condensation reaction or by a ring-opening polymerization of a cyclic lactide monomer in catalyzed or uncatalyzed processes. Methodologies for the preparation of PLA are described in U.S. Pat. Nos. 6,323,307; 5,216,050; 4,387,769; 3,912,692; and 2,703,316, each of which is incorporated by reference herein in its entirety. In an embodiment, the aliphatic polyester is a homopolymer or copolymer comprising substituted or unsubstituted ε-caprolactone.

In an embodiment, the DM comprises an aromatic polyester which comprises an aromatic group in the polymer backbone. An example of an aromatic polyester suitable for use in the present disclosure is polyethylene terephthalate ester (PETE or PET). PETE is an amorphous or semi-crystalline thermoplastic polymer. In an embodiment the DM is a PETE whose monomeric units are characterized by Formula III where n has a value ranging from about 50 to about 500, alternatively from about 100 to about 300 or alternatively from about 150 to about 300.

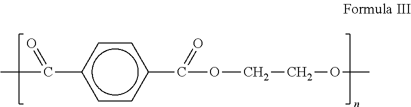

In an embodiment, the PETE is recycled PETE. Herein “recycled PETE” refers to PETE that has initially been formed into one or more articles and subsequently identified as waste material. The waste material was then subjected to a mechanical process resulting in the material losing the form of the article while maintaining polymer properties similar to PETE that has not been previously formed into an article and/or designated as waste material.

The physical properties associated with the degradable polymer may depend upon several factors including, but not limited to, the composition of the repeating units, flexibility of the polymer chain, the presence or absence of polar groups, polymer molecular mass, the degree of branching, polymer crystallinity, polymer orientation, or the like. For example, a polymer having substantial short chain branching may exhibit reduced crystallinity while a polymer having substantial long chain branching may exhibit for example, a lower melt viscosity and impart, inter alia, elongational viscosity with tension-stiffening behavior. The properties of the degradable polymer may be further tailored to meet some user and/or process designated goal using any suitable methodology such as blending and copolymerizing the degradable polymer with another polymer, or by changing the macromolecular architecture of the degradable polymer (e.g., hyper-branched polymers, star-shaped, or dendrimers, etc.).

In an embodiment, in choosing the appropriate degradable polymer, an operator may consider the degradation products that will result. For example, an operator may choose the degradable polymer such that the resulting degradation products are soluble in the wellbore fluids, and do not adversely affect one or more other operations, treatment components, the formation, or combinations thereof. Additionally, the choice of degradable polymer may also depend, at least in part, upon the conditions of the well. In an embodiment, the degradable polymer and/or its degradation products are biodegradable where biodegradable refers to the ability of a material to be decomposed by a living organism.

Nonlimiting examples of additional degradable polymers suitable for use in conjunction with the methods of this disclosure are described in more detail in U.S. Pat. Nos. 7,565,929 and 8,109,335, and U.S. Patent Publication Nos. 20100273685 A1, 20110005761 A1, 20110056684 A1 and 20110227254 A1, each of which is incorporated by reference herein in its entirety. Additional descriptions of degradable polymers suitable for use in the present disclosure may also be found in the publication of Advances in Polymer Science, Vol. 157 entitled “Degradable Aliphatic Polyesters” edited by A. C. Albertsson, which is incorporated herein in its entirety.

A variety of additives may be included with DMs of the type disclosed herein, such as thermoplastics, by meltblending during processing or during the manufacturing phase to modify the properties of the base polymer to suit the intended applications. In an embodiment, the degradable polymer further comprises a plasticizer. The plasticizer may be present in an amount sufficient to provide one or more desired characteristics, for example, (a) more effective compatibilization of the melt blend components, (b) improved processing characteristics during the blending and processing steps, (c) control and regulation of the sensitivity and degradation of the polymer by moisture, or combinations thereof. Plasticizers suitable for use in the present disclosure include, but are not limited to, derivatives of oligomeric lactic acid, such as those represented by the Formula IV:

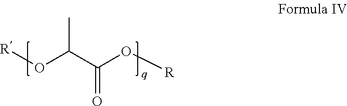

where R and/or R′ are each hydrogen, an alkyl group, an aryl group, an alkylaryl group, an acetyl group, a heteroatom, or combinations thereof provided that R and R′ cannot both be hydrogen and that both R and R′ are saturated; q is an integer where the value of q ranges from greater than or equal to 2 to less than or equal to 75 or alternatively from greater than or equal to 2 to less than or equal to 10. As used herein the term “derivatives of oligomeric lactic acid” may include derivatives of oligomeric lactide. In an embodiment where a plasticizer of the type disclosed herein is used, the plasticizer may be intimately incorporated within the degradable polymeric materials.

Examples of other additives that may be included with DMs of the type disclosed herein include without limitation nucleating agents, antioxidants, thermal processing stabilizers, impact modifiers, mineral fillers, glass fibers, internal desiccants and the like.

Nonlimiting examples of polyester-based DMs suitable for use in this disclosure include BIOVERT NWB diverting agent, BIOVERT CF diverting agent, or combinations thereof. BIOVERT NWB diverting agent is a near-wellbore temporary biodegradable diverting agent; and BIOVERT CF diverting agent is a complex fracture temporary biodegradable diverting agent; each of which is commercially available from Halliburton Energy Services. PETE is supplied under a variety of trade names, such as DACRON, TERYLENE, FORTREL, MYLAR, TRITAN and TEIJIN by many suppliers. A list of suppliers for container grade PETE can be obtained from the National Association for PET Container Resources (NAPCOR), Sonoma, Calif., USA.

In an embodiment, the DM is combined with one or more additional components, for example an aqueous or non-aqueous base fluid and optionally one or more additives, to form a pumpable wellbore servicing fluid of the type described herein. In an embodiment, the DM is present in a wellbore servicing fluid in an amount of from about 1 lb/1000 gallons to about 1000 lb/1000 gallons alternatively from about 10 lb/1000 gallons to about 500 lb/1000 gallons, or alternatively from about 50 lb/1000 gallons to about 250 lb/1000 gallons.

In an embodiment, a DA comprises a material that functions to enhance the rate of degradation of a DM. The DM may be degraded via hydrolytic or aminolytic degradation in the presence of a DA. In an embodiment, the DA comprises an inorganic base, an organic base, precursors thereof or combinations thereof. In an embodiment, the DA is a base or base precursor. A base precursor (i.e., base-producing material) includes any compound capable of generating hydroxyl ions (HO) in water. It is to be understood that the base precursor can include chemicals that produce a base when reacted together. Without limitation, examples of base-producing reactions include the reaction of an oxide with water, or an organic amine dissolved in water. Nonlimiting examples of base precursors suitable for use in this disclosure include ammonium and alkali metal carbonates and bicarbonates, alkali and alkaline earth metal oxides, alkali and alkaline earth metal hydroxides, alkali and alkaline earth metal phosphates, alkali and alkaline earth metal sulphides, alkali and alkaline earth metal salts of silicates and aluminates, alkali alkaline earth metal carboxylates, water soluble or water dispersible organic amines, polymeric amines, amino alcohols, or combinations thereof.

Nonlimiting examples of alkali metal carbonates and bicarbonates suitable for use in this disclosure include Na₂CO₃, K₂CO₃, NaHCO₃, KHCO₃. It is to be understood that when carbonate and bicarbonate salts are used as base-producing material, a byproduct may be carbon dioxide.

Nonlimiting examples of alkali and alkali earth metal hydroxides suitable for use in this disclosure include NaOH, NH₄OH, KOH, LiOH, Ca(OH)₂ and Mg(OH)₂. In an embodiment, the DA is selected from sodium or potassium hydroxide.

Nonlimiting examples of alkali and alkali earth metal oxides suitable for use in this disclosure include BaO, SrO, Li₂O, CaO, Na₂O, K₂O, MgO, and the like. Nonlimiting examples of alkali and alkali earth metal phosphates and hydrogen phosphates suitable for use in this disclosure include Na₃PO₄, Ca₃(PO₄)₂, and the like. Nonlimiting examples of alkali and alkali earth metal sulphides suitable for use in this disclosure include Na₂S, CaS, SrS, and the like. Examples of alkali and alkaline earth metal silicates and aluminates include sodium silicate, potassium silicate, sodium metasilicate, sodium aluminate, calcium aluminate and the like, or combinations thereof. In an embodiment, the base comprises silicate and aluminate salts having some solubility in aqueous solutions. Other examples of bases suitable for use as DAs in this disclosure are described in more detail in U.S. Patent Publication No. 20100273685 A1, which is incorporated by reference herein in its entirety.

In an embodiment, the base or base precursor is encapsulated. In an embodiment the pH of a wellbore servicing fluid comprising the DA is greater than about 9, alternatively greater than about 10, or alternatively greater than about 11. In an embodiment, the pKa of the conjugate acid of the organic amine compound is greater than about 9, alternatively greater than about 10, or alternatively greater than about 11.

In an embodiment, the wellbore servicing fluid comprises a phase transfer catalyst (PTC). The PTC may comprise a material that functions to enhance the rate of degradation of a DM by a DA of the type disclosed herein. Without wishing to be limited by theory, a PTC enables the transfer of chemical species (e.g., hydroxide ion) between two phases (i.e., solid phase and liquid phase). As will be understood by one of ordinary skill in the art, the PTC enables the transfer of the chemical species but does not participate in the chemical reaction between the chemical species and the phase into which it is being transferred. Without wishing to be limited by theory, the PTC functions as a catalyst in a heterogeneous catalysis process.

In an embodiment, the PTC comprises a cationic compound that (i) is water dispersible; (ii) has a water solubility less than about 5 wt. %, alternatively less than about 2 wt. %, or alternatively less than about 1 wt. %; (iii) has a logarithmic octanol-water distribution coefficient, Log D_{OW}, greater than about 1, alternatively greater than about 2, or alternatively greater than about 3; and/or (iv) has a hydrophilic-lipophilic balance (HLB) ratio of from about 7 to about 11. The water solubility of a compound may be defined as the maximum amount of the compound that will dissolve in pure water at a specified temperature and pressure. Herein the solubility in wt. % refers to grams of dissolved substance in 100 grams of water. The Log D_{OW} of a compound may be defined as the ratio of the compound's concentration in a known volume of n-octanol to its concentration in a known volume of water after the octanol and water have reached equilibrium. D_{OW} may be determined by the Shake Flask method or High Pressure Liquid Chromatography (HPLC) HLB ratio is defined as a ratio of hydrophilic and lipophilic groups of a surfactant, and is a measure of the balance between the oil-soluble and water-soluble moieties in a surface active material (i.e., a surfactant) HLB values range between 0-60, with smaller vales (for example, <10) representing oil-soluble surfactants with affinity for hydrophobic fluids and higher values (for example >10) representing water soluble surfactants with affinity for aqueous or hydrophilic fluids.

In an embodiment, the PTC comprises a cationic surfactant. Without wishing to be limited by theory, a surfactant may be defined as a compound that lowers the interfacial tension between a liquid and a solid, at the interface (i.e., where the liquid phase and the solid phase contact each other). In an embodiment, the cationic PTC comprises a quaternary ammonium salt, a quaternary phosphonium salt, a quaternary arsonium compound, alkyl pyridinium salts or combinations thereof.

Nonlimiting examples of quaternary ammonium salts suitable for use in this disclosure include trioctylmethylammonium chloride (TOMAC), tri(decyl)methylammonium chloride, tricetylmethylammonium chloride (TCMAC), dimethyl(hydrogenatedtallow)benzyl ammonium chloride (DMHTBAC), di(dodecyl)benzylmethylammonium chloride, tetraheptylammonium chloride, di(cetyl)dimethylammonium chloride, tri(decyl)benzylammonium chloride or combinations thereof. In an embodiment, the cationic PTC is not the conjugate acid salt obtained by protonation of a tertiary amine by an acid. In an embodiment, the structure of the cationic phase transfer catalyst is not pH-sensitive.

In an embodiment, the quaternary ammonium salt may be obtained from tertiary amines of the type described herein via a Menshutkin reaction. Without wishing to be limited by theory, the Menshutkin reaction is an alkylation reaction of tertiary amines where the alkylation agent is an alkyl halide. Nonlimiting examples of alkyl halides suitable for use in this disclosure include methyl chloride, methyl bromide, ethyl chloride, ethyl bromide, propyl chloride, propyl bromide, butyl bromide, and the like. In an embodiment, tertiary amines suitable for the Menshutkin reaction as previously described herein comprise an amine generally represented by Formula V:

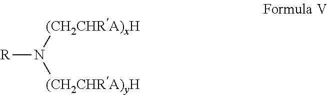

where R is an organic group having from about 12 to about 22 carbon atoms (e.g., a C₁₂ to C₂₂), R′ is independently selected from hydrogen or C₁ to C₃ alkyl group, A is NH or O, and the sum of x and y ranges from about 1 to about 3, alternatively, from 1 to 3 (e.g., 1<x+y<3), or alternatively, from greater than 1 to less than 3 (e.g., 1<x+y<3). In an embodiment, the R group may be a C₁₂ to C₂₂ aliphatic hydrocarbon. In an additional embodiment, R may be a non-cyclic aliphatic. In an embodiment, the R group comprises at least one degree of unsaturation. For example, at least one carbon-carbon double bond may be present within the R group. Examples of suitable R groups include, but are not limited to, commercially recognized mixtures of aliphatic hydrocarbons such as soya, which is a mixture of C₁₄ to C₂₀ hydrocarbons, or tallow which is a mixture of C₁₆ to C₂₀ aliphatic hydrocarbons, or tall oil which is a mixture of C₁₄ to C₁₈ aliphatic hydrocarbons. In a particular embodiment in which the A group comprises NH, the sum of x and y may be 2 and the value of x may be 1. In yet another embodiment in which the A group comprises 0, the sum of x and y may be 2 and the value of x may be 1.

In another embodiment, a tertiary amine suitable for the Menshutkin reaction as previously described herein comprises an amine generally represented by Formula VI:

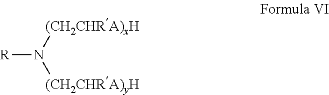

where R is a cycloaliphatic hydrocarbon, each R′ may be the same or different and is H or an alkyl having from about 1 to about 3 carbon atoms, each A may be the same or different and is NH or O, and the sum of x and y ranges from about 1 to about 20, alternatively, from 1 to 20 (e.g., 1<x+y<20), or alternatively, from greater than 1 to less than 20 (e.g., 1<x+y<20). In an embodiment, R comprises an aromatic group. In an embodiment, R comprises abietyl, hydroabietyl, dihydroabietyl, tetrahydroabietyl, or dehydroabietyl; R′ is H; and A is O. In another embodiment, the amine is an ethoxylated rosin amine. As used herein, the term “rosin amine” refers to the primary amines derived from various rosins or rosin acids, whereby the carboxyl of the rosin or rosin acid is converted to an amino (—NH₂) group. Examples of suitable rosin amines include, but are not limited to, gum and wood rosin amines containing abietyl, rosin amine derived from hydrogenated gum or wood rosin and primarily containing dehydroabietylamine, rosin amine derived from hydrogenated gum or wood rosin and containing dihydro- and tetrahydroabietylamine, heat-treated rosin amine derived from heat-treated rosin, polymerized rosin amine derived from polymerized rosin, isomerized rosin amine derived from isomerized rosin and containing substantial amounts of abietylamine, rosin amines derived from pure rosin acids (e.g., abietylamine, dihydroabietylamine, dehydroabietylamine, tetrahydroabietylamine), or combinations thereof.

Nonlimiting examples of quaternary phosphonium salts suitable for use in this disclosure include hexadecyltributylphosphonium bromide, tetrabutylphosphonium chloride, tri(butyl)octylphosphonium chloride, tri(butyl)hexadecylphosphonium chloride, or combinations thereof. In an embodiment, the quaternary phosphonium salt is tri(butyl)hexadecylphosphonium chloride. Quaternary phosphonium compounds suitable for use in the present disclosure are commercially available under the trade name of CYPHOS from Cytec Industries, Woodland Park, N.J., USA.

In an embodiment, the DA and PTC are combined with one or more additional components, for example an aqueous or non-aqueous base fluid and optionally one or more additives, to form a pumpable wellbore servicing fluid of the type described herein. In an embodiment, the DA and the PTC are each present in the wellbore servicing fluid in amounts effective to perform its intended function. Thus, the amount of DA may range from about 0.5 wt. % to about 20 wt. %, alternatively from about 1 wt. % to about 10 wt. %, or alternatively from about 2 wt. % to about 5 wt. %, based on the weight of wellbore servicing fluid while the amount of PTC may range from about 0.001 wt. % to about 2 wt. %, alternatively from about 0.01 wt. % to about 1 wt. %, or alternatively from about 0.1 wt. % to about 0.5 wt. %, based on the weight of the wellbore servicing fluid.

In an embodiment, a wellbore servicing fluid comprises a degradation accelerator (DA) and a PTC. In an embodiment, a wellbore servicing fluid comprises an inorganic base and a PTC. PTCs of the type disclosed herein may catalyze the degradation of DMs of the type disclosed herein. In an embodiment, a DA/PTC combination suitable for use in the present disclosure produces water-soluble degradation products. For example, the DA/PTC when contacted with a DM of the type disclosed herein (e.g., when contacted in situ within the wellbore) produces degradation products that are in the salt form, for example the alkali metal salt (e.g, the sodium salt of the degradation product). The salt form of the degradation product is readily soluble in water.

In an embodiment, the DM comprises PETE, the DA comprises NaOH, and the PTC comprises TOMAC. In such embodiments, the DM may be combined with one or more additional components (e.g., an aqueous or non-aqueous base fluid and one or more additives) to form a first pumpable wellbore servicing fluid for placement of the DM in the wellbore and/or surrounding formation, and the DA and PTC may be combined with one or more additional components (e.g., an aqueous or non-aqueous base fluid and one or more additives) to form a subsequent (e.g., second) pumpable wellbore servicing fluid for placement of the DA and PTC in the wellbore and/or surrounding formation proximate (i.e., in contact with) the DM.

In another embodiment, the DM comprises PLA, the DA comprises NaOH, and the PTC comprises DMHTBAC. In such embodiments, the DM may be combined with one or more additional components (e.g., an aqueous or non-aqueous base fluid and one or more additives) to form a first pumpable wellbore servicing fluid for placement of the DM in the wellbore and/or surrounding formation, and the DA and PTC may be combined with one or more additional components (e.g., an aqueous or non-aqueous base fluid and one or more additives) to form a subsequent (e.g., second) pumpable wellbore servicing fluid for placement of the DA and PTC in the wellbore and/or surrounding formation proximate (i.e., in contact with) the DM.

In yet another embodiment the DM comprises PETE and the DA comprises NaOH. In such embodiments, the DM may be combined with one or more additional components (e.g., an aqueous or non-aqueous base fluid and one or more additives) to form a first pumpable wellbore servicing fluid for placement of the DM in the wellbore and/or surrounding formation, and the DA and PTC may be combined with one or more additional components (e.g., an aqueous or non-aqueous base fluid and one or more additives) to form a subsequent (e.g., second) pumpable wellbore servicing fluid for placement of the DA and PTC in the wellbore and/or surrounding formation proximate (i.e., in contact with) the DM.

In still yet another embodiment, the DM comprises a PLA/PGA copolymer, the DA comprises NaOH and the PTC comprises TOMAC. In such embodiments, the DM may be combined with one or more additional components (e.g., an aqueous or non-aqueous base fluid and one or more additives) to form a first pumpable wellbore servicing fluid for placement of the DM in the wellbore and/or surrounding formation, and the DA and PTC may be combined with one or more additional components (e.g., an aqueous or non-aqueous base fluid and one or more additives) to form a subsequent (e.g., second) pumpable wellbore servicing fluid for placement of the DA and PTC in the wellbore and/or surrounding formation proximate (i.e., in contact with) the DM.

A DM of the type disclosed herein may be included in any suitable wellbore servicing fluid. A DA and PTC of the type disclosed herein may be included in any suitable wellbore servicing fluid. As used herein, a “servicing fluid” refers to a fluid used to drill, complete, work over, fracture, repair, or in any way prepare a wellbore for the recovery of materials residing in a subterranean formation penetrated by the wellbore. Examples of wellbore servicing fluids include, but are not limited to, cement slurries, drilling fluids or muds, spacer fluids, lost circulation fluids, fracturing fluids, diverting fluids or completion fluids. The servicing fluid is for use in a wellbore that penetrates a subterranean formation. It is to be understood that “subterranean formation” encompasses both areas below exposed earth and areas below earth covered by water such as ocean or fresh water. In an embodiment, the wellbore servicing fluid is a diverting fluid comprising a DM and/or a DA/PTC combination.

In an embodiment, the DM and the DA/PTC combination may be added to the same wellbore servicing fluid and delivered into the wellbore as a single stream wellbore servicing fluid. In another embodiment, the DM may be added to the wellbore servicing fluid and delivered into the wellbore as a first wellbore servicing fluid stream. Once the DM has served its purpose, the DA/PTC combination may be delivered into the wellbore as a subsequent (e.g., second) wellbore servicing fluid stream, to effect the degradation of the DM. In various embodiments, one or more additional wellbore servicing fluids (e.g., fracturing fluids, drilling fluids, production enhancement fluids such as acidizing fluids, etc.) may be placed into the wellbore and/or surrounding formation intermediate the first wellbore servicing fluid comprising a DM and a subsequent wellbore servicing fluid comprising a DA/PTC combination.

In an embodiment, the DA and the PTC may be mixed together prior to adding them into the wellbore servicing fluid. In another embodiment, the DA and the PTC are added simultaneously to the wellbore servicing fluid. In yet another embodiment, the DA is added first to the wellbore servicing fluid, and then the PTC is added to the wellbore servicing fluid. In another embodiment, the PTC is added first to the wellbore servicing fluid, and then the DA is added to the wellbore servicing fluid.

In an embodiment, the DA and the PTC are manufactured and then mixed together at the well site. Alternatively, the DA and the PTC are manufactured and then mixed together off-site. In another embodiment, either the DA or the PTC is preformed and the other one would be made on-the-fly (e.g., in real time or on-location), and the two materials would then be mixed together on-the-fly. When manufactured or assembled off site, the DA, PTC and/or combination thereof may be transported to the well site.

In an embodiment, a DA/PTC combination may be prepared in the form of a concentrated liquid additive. In an embodiment, the DA/PTC concentrated liquid additive and a wellbore servicing fluid may be mixed until the DA/PTC are distributed throughout the fluid. By way of example, the DA/PTC concentrated liquid additive and a wellbore servicing fluid may be mixed using a mixer, a blender, a stirrer, a jet mixing system, or other suitable device.

When it is desirable to prepare a wellbore servicing fluid of the type disclosed herein (i.e., a diverting fluid) for use in a wellbore, a base diverting fluid prepared at the wellsite or previously transported to and, if necessary, stored at the on-site location may be combined with the DM, additional water and optional other additives to form the diverting fluid. In an embodiment, additional DMs may be added to the diverting fluid on-the-fly along with the other components/additives. The resulting diverting fluid may be pumped downhole where it may function as intended (e.g., depositing the diverting material in a desired location downhole).

In an embodiment, a DA/PTC concentrated liquid additive is mixed with additional water to form a diluted liquid additive, which is subsequently added to a wellbore servicing fluid (e.g., a degrading fluid). The additional water may comprise fresh water, salt water such as an unsaturated aqueous salt solution or a saturated aqueous salt solution, or combinations thereof. In an embodiment, the liquid additive comprising the DA/PTC is injected into a delivery pump being used to supply the additional water to a fluid composition. As such, the water used to carry the DA/PTC and this additional water are both available to the fluid such that the DA/PTC may be distributed throughout the servicing fluid (e.g., a degrading fluid).

In an alternative embodiment, the DA/PTC combination prepared as a liquid additive is combined with a ready-to-use wellbore servicing fluid (e.g., a degrading fluid) as the fluid is being pumped into the wellbore. In such embodiments, the DA/PTC liquid additive may be injected into the suction of the pump. In such embodiments, the liquid additive can be added at a controlled rate to the fluid (e.g., or a component thereof such as blending water) using a continuous metering system (CMS) unit. The CMS unit can also be employed to control the rate at which the liquid additive is introduced to the fluid or component thereof as well as the rate at which any other optional additives are introduced to the fluid or component thereof. As such, the CMS unit can be used to achieve an accurate and precise ratio of water to DA/PTC concentration in the fluid such that the properties of the fluid (e.g., density, viscosity), are suitable for the downhole conditions of the wellbore. The concentrations of the components in the fluid, e.g., the DA/PTC components, can be adjusted to their desired amounts before delivering the composition into the wellbore. Those concentrations thus are not limited to the original design specification of the fluid and can be varied to account for changes in the downhole conditions of the wellbore that may occur before the composition is actually pumped into the wellbore.

In an embodiment, the DM is physically combined with a PTC by addition to a wellbore servicing fluid to form a pumpable first wellbore servicing fluid for placement of the DM. The DA (e.g., sodium hydroxide) may be added to a subsequent wellbore servicing fluid to form a second wellbore servicing fluid. In an embodiment, the DM and PTC are contacted to form a composite material (i.e. DM/PTC). For example, the solid DM may be treated with a PTC of the type disclosed herein by any suitable methodology. For example, when the PTC is a low-melting solid, the PTC may be melt-coated onto the DM by hot rolling or jet-spraying. Alternatively, the DM may be spray coated with solutions of a PTC in organic solvents such as oxygenated solvents, and dried. Alternatively, the DM may be melt-blended with the PTC. A first pumpable wellbore servicing fluid containing PTC-treated-DM material may be placed in the wellbore, and/or the surrounding formation. A second wellbore servicing fluid comprising a DA solution (e.g., a sodium hydroxide solution) may be then contacted with a PTC-treated DM.

In an embodiment, the size and/or shape of the DM may be chosen so as to provide a plug (e.g., filter cake) within a given flowpath (e.g., within a point of entry into the wellbore and/or at a given distance from the wellbore within a fracture) having a given size, shape, and/or orientation. In an embodiment, the DM and/or the DM/PTC may be added to the wellbore servicing fluid to generate a diverting fluid which is then pumped downhole at the same time with additional diverting material.

In an embodiment, the DM once placed downhole enters the formation and forms a diverter plug within a flowpath thereby temporarily lowering the permeability of, and fluid loss to, the flowpath. Because of the wide array of flowpaths, induced or natural, and geometries it is challenging to specify the characteristics of the diverting plug or cake that may be formed by DMs in the flowpath. The effectiveness of a DM treatment in diversion applications may be indicated by an increase in pump pressure during DM placement upon formation of a competent plug or filtercake in the flowpath. By monitoring the pressure increase during the pumping phase of a DM fluid, decisions can be made either to modify the fluid design, for example by changing the concentration of DM, or to proceed with the operation (for example, fracturing at a different cluster of perforations). A pressure increase of greater than about 100 psi, alternatively greater than about 200 psi, or alternatively greater than about 400 psi may be taken as indicative of competent plug formation in a flowpath.

In an embodiment, the DM may be configured, for example, via selection of a given size and/or shape, for placement at a given position (e.g., at a given depth of the wellbore) within such a flowpath. Without wishing to be limited by theory, where it is desired that a diverter plug forms in the near-wellbore region, the DM may be selected so as to have a larger particle size (e.g., greater than about 1 mm in diameter or less than about 18 U.S. mesh size); alternatively, where it is desired that a diverter plug forms in the far-wellbore region, the DM may be selected so as to have a smaller particle size (e.g., smaller than about 500 microns in diameter or greater than about 35 U.S mesh size). The near-wellbore region delimitation is dependent upon the formation where the wellbore is located, and is based on the wellbore surrounding conditions. The far-wellbore region is different from the near-wellbore region in that it is subjected to an entirely different set of conditions and/or stimuli. In an embodiment, the near-wellbore and far-wellbore regions are based on the fracture length propagating away from the wellbore. In such embodiments, the near-wellbore region refers to about the first 20% of the fracture length propagating away from the wellbore (e.g., 50 feet), whereas the far-wellbore region refers to a length that is greater than about 20% of the fracture length propagating away from the wellbore (e.g., greater than about 50 feet). Again, without wishing to be limited by theory, smaller diverter particles may be carried a greater distance into the formation (e.g., into an existing and/or extending fracture).

A method of servicing a wellbore may further comprise placing a wellbore servicing fluid (e.g., fracturing or other stimulation fluid such as an acidizing fluid) into a portion of a wellbore following placement of the DM via a wellbore servicing fluid (e.g., a diverter fluid). In such embodiments, the fracturing or stimulation fluid may be diverted from the area (e.g., zone) proximate the DM and enter other flow paths (e.g., fractures/zones) and perform its intended function of increasing the production of a desired resource from that portion of the wellbore. Such services may be on newly completed wells or on remedial or workover services. For example, the level of production from the portion of the wellbore that has been previously produced and/or stimulated may taper off over time such that stimulation of a different portion of the well is desirable. Additionally or alternatively, previously formed flowpaths may need to be temporarily plugged in order to fracture or stimulate additional/alternative intervals or zones during a given wellbore service or treatment (e.g., in order to complete a multi-zone fracturing treatment). In an embodiment, an amount of a diverting fluid (e.g., wellbore servicing fluid comprising a DM) sufficient to effect diversion of a subsequent wellbore servicing fluid from a first flowpath to a second flowpath is delivered to the wellbore. The diverting fluid may form a temporary plug, also known as a diverter plug or diverter cake, once disposed within the first flowpath which restricts entry of a subsequent wellbore servicing fluid (e.g., fracturing or stimulation fluid) into the first flowpath. The diverter plug deposits onto the face or into the crevices of the formation and creates a temporary skin or structural, physical and/or chemical obstruction that decreases the permeability of the zone. The subsequent wellbore servicing fluid restricted from entering the first flowpath may enter one or more additional flowpaths and perform its intended function. Within a first treatment stage, the process of introducing a wellbore servicing fluid into the formation to perform an intended function (e.g., fracturing or stimulation) and, thereafter, diverting the wellbore servicing fluid to another flowpath into the formation and/or to a different location or depth within a given flowpath may be continued until some user and/or process goal is obtained. In an additional embodiment, this diverting procedure may be repeated with respect to each of a second, third, fourth, fifth, sixth, or more, treatment stages, for example, as disclosed herein with respect to the first treatment stage. That is, in one or more successive stages of a production enhancement treatment, at or near completion of a given stage or zone, a slug of a diverter fluid (and/or DM may be added into the treatment fluid) such that the DM plugs the zone most recently treated and diverts subsequent treatment fluid to an alternative/successive zone or stage for treatment. In an embodiment, the wellbore servicing operation comprises proppant diversion. In an alternative embodiment, the wellbore servicing operation comprises diversion of treatment fluids such as cleanup or surfactant-containing fluids.

In an embodiment, the wellbore service being performed is a fracturing operation, wherein a fracturing fluid is placed (e.g., pumped downhole) at a first location in the formation and a DM is employed to divert the fracturing fluid from the first location to a second location in the formation such that fracturing can be carried out at a plurality of locations. The DM may be placed into the first (or any subsequent location) via pumping a slug of a diverter fluid (e.g., a fluid having a different composition than the fracturing fluid, for example a fracturing fluid further comprising a DM) containing the DM and/or by adding the DM directly to the fracturing fluid, for example to create a slug of fracturing fluid comprising the DM. The DM may form a diverter plug at the first location (and any subsequent location so treated) such that the fracturing fluid may be selectively placed at one or more additional locations, for example during a multi-stage fracturing operation. In an embodiment, the DM is added to an aqueous fracturing fluid comprising proppant material and optionally one or more additives such as gelling agents, and such DM-loaded fracturing fluid is used to form the diverter plug downhole.

In an embodiment, following a wellbore servicing operation utilizing a diverting fluid (e.g., a wellbore servicing fluid comprising a DM), the wellbore and/or the subterranean formation may be prepared for production, for example, production of a hydrocarbon, therefrom. In an embodiment, preparing the wellbore and/or formation for production may comprise removing a DM (which has formed a temporary plug) from one or more flowpaths, for example, by allowing the diverting materials therein to degrade in a timely manner and subsequently recovering hydrocarbons from the formation via the wellbore with a minimum delay subsequent to the stimulation or any other production-enhancing operation.

In an embodiment the DM comprises a degradable polymer of the type previously disclosed herein (e.g., PETE), which degrades due to, inter alia, a chemical process such as hydrolysis. In an embodiment, a hydrophobic DM (e.g., PETE) may be contacted with a DA/PTC of the type disclosed herein (e.g., a hydroxide-containing DA such as NaOH). Without wishing to be limited by theory, the PTC may facilitate the interaction of the hydrophobic DM with the hydrophilic DA. In an embodiment, the DM degradation rate in the presence of a DA/PTC may be increased with respect to the DM degradation in the presence of the DA by a factor of about 2, alternatively by a factor of about 100, or alternatively by a factor of about 20.

In an embodiment, the DM when subjected to degradation conditions of the type disclosed herein (e.g., in the presence of a DA/PTC) degrades in a time range of about 10 h, alternatively about 24 h, or alternatively about 72 h. Alternatively, in another embodiment, DMs of the type disclosed herein due to the presence of a DA/PTC combination of the type disclosed herein substantially degrades in a time frame of less than about 1 week, alternatively less than about 2 days, or alternatively less than about 1 day.

In an embodiment, the degradation of a DM results in DM degradation products. In an embodiment, the DM degradation products are water-soluble and may solubilize into the wellbore servicing fluid present in the wellbore. In one embodiment, the DM degradation products comprise carboxylates (e.g., —COO⁻), i.e., salts or esters of carboxylic acids that are soluble in the wellbore servicing fluid. When the degradation of the DM occurs in the presence of an alkali metal base (e.g., NaOH), the DM degradation products may comprise alkali metal carboxylates (e.g., —COO⁻Na or the sodium salt of carboxylic acid).

In an embodiment, upon degrading the DM, the wellbore may be subjected to additional wellbore cleanout or stimulation treatments, such as acidizing treatments. Acidizing treatments may be carried out as “matrix acidizing” procedures or as “acid fracturing” procedures. Generally, in acidizing treatments, aqueous acidic solutions are introduced into the subterranean formation under pressure so that the acidic solution flows into the pore spaces of the formation to remove near-well formation damage and other damaging substances. The acidic solution reacts with acid-soluble materials contained in the formation which results in an increase in the size of the pore spaces and an increase in the permeability of the formation. This procedure commonly enhances production by increasing the effective well radius. When performed at pressures above the pressure required to fracture the formation, the procedure is often referred to as acid fracturing. Fracture-acidizing involves the formation of one or more fractures in the formation and the introduction of an aqueous acidizing fluid into the fractures to etch the fractures' faces whereby flow channels are formed when the fractures close. The aqueous acidizing fluid also enlarges the pore spaces in the fracture faces and in the formation. In fracture-acidizing treatments, one or more fractures are produced in the formation and the acidic solution is introduced into the fracture to etch flow channels in the fracture face. The acid also enlarges the pore spaces in the fracture face and in the formation. The use of the term “acidizing” herein refers to both types of acidizing treatments, and more specifically, refers to the general process of introducing an acid down hole to perform a desired function, e.g., to acidize a portion of a subterranean formation or any damage contained therein. Acidizing treatments are described in more detail in U.S. Pat. No. 7,926,568, which is incorporated by reference herein in its entirety.

In an embodiment, the DM degradation products (e.g., sodium carboxylates, —COO⁻Na⁺ such as disodium terephthalate from degradation of PETE with a DA comprising sodium hydroxide) may be flowed back to the surface, and contacted with an acidic fluid (e.g., acidizing fluid) which will cause conversion of the carboxylates to carboxylic acids (for example, terephthalic acid). The carboxylic acids may be insoluble in the acidizing fluid and precipitate from the solution. In some embodiments, at least a portion of the insoluble DM degradation products are recovered. In some embodiments, the acidizing fluid comprising the recovered insoluble DM degradation products are introduced in the wellbore for an acidizing treatment, and the insoluble DM degradation products deposited into the formation flowpaths previously created thereby diverting the acid fluids into other untreated flowpaths.

In an alternative embodiment, upon degrading the DM, and while the DM degradation products are still present within the wellbore, an acidizing fluid is introduced into the wellbore. In such an embodiment, the DM degradation products (e.g., sodium carboxylates, —COO⁻Na⁺) upon contact with the acidizing fluid may be converted to the carboxylic acid form of the DM degradation product which is insoluble in the acidizing fluid. In such embodiments, the insoluble DM degradation products may precipitate in the wellbore and function to facilitate the acidizing operation.

Subsequent to the acidizing operation, removal of the insoluble DM degradation products from the wellbore may occur when the well is placed into production and the produced hydrocarbons contact the water-insoluble DM degradation products.

In another embodiment, the DM comprises a material which is characterized by the ability to be degraded at bottom hole temperatures (BHT) of less than about 110° F., alternatively less than about 160° F., or alternatively less than about 220° F. in the presence of DA/PTC of the type disclosed herein.

In an embodiment, DA/PTC combinations of the type disclosed herein may be advantageously designed to provide some user and/or process desired degradation time for DMs of the type disclosed herein.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

The properties of a DM comprising a hydrophobic polymer were investigated. More specifically, the degradation of PETE in the presence of various DAs and PTCs of the type disclosed herein was monitored over time at a constant temperature of 180° F., and the results are displayed in Table 1. For each sample in Table 1, a 10 g solution was made by mixing 1 g of ground recycled PETE with either fresh water, a 1% NaOH solution, or a 4% NaOH solution. Two different PTCs were used as noted in Table 1, TOMAC and TCMAC. At the end of the specified duration, the reaction mixture was filtered and the dry weight of the undegraded PETE was determined. For the blank cells in Table 1, no data was collected. All concentrations in Table 1 are reported as the wt. % based on the total weight of the solution.

TABLE 1

| | Residual Polymer | Residual Polymer |
|---|---|---|
| Degradation Accelerator | Weight [g] 18 h | Weight [g] 72 h |
| Control (fresh water) | 1.0 | 1.0 |
| 4% NaOH | 0.55 | 0.31 |
| 4% NaOH + TOMAC (1%) | 0.1 | 0.07 |
| 4% NaOH + TOMAC (0.5%) | 0.09 | — |
| 4% NaOH + TCMAC (1%) | 0.45 | — |
| 1% NaOH + TOMAC (0.5%) | — | 0.94 |

The results demonstrate that even at 180° F., PETE in the presence of fresh water did not degrade. The 4% NaOH solution was effective in breaking down PETE, after 18 h, 45% of the PETE was degraded, and by 72 h, 69% of the PETE was degraded. When a PTC was added to the 4% NaOH solution, the degradation of PETE was accelerated, when compared to the degradation of PETE when contacted with a 4% NaOH solution alone. For each of the TOMAC concentrations (e.g., 0.5% and 1%) used in conjunction with a 4% NaOH solution, the PETE was about 90% degraded after 18 hours and about 93% degraded after 72 hours. The degradation of PETE also increased in the presence of 1% TCMAC and a 4% NaOH solution, where PETE degradation was at about 55% after 18 h. When TOMAC was used as a 0.5% solution in conjunction with a 1% NaOH solution, there was little degradation of PETE after 72 h (approximately 6%). The results demonstrate that the utilization of TOMAC or TCMAC in conjunction with a NaOH solution enhanced the rate of degradation of PETE when compared to the rate of degradation utilizing a NaOH solution alone.

### Example 2

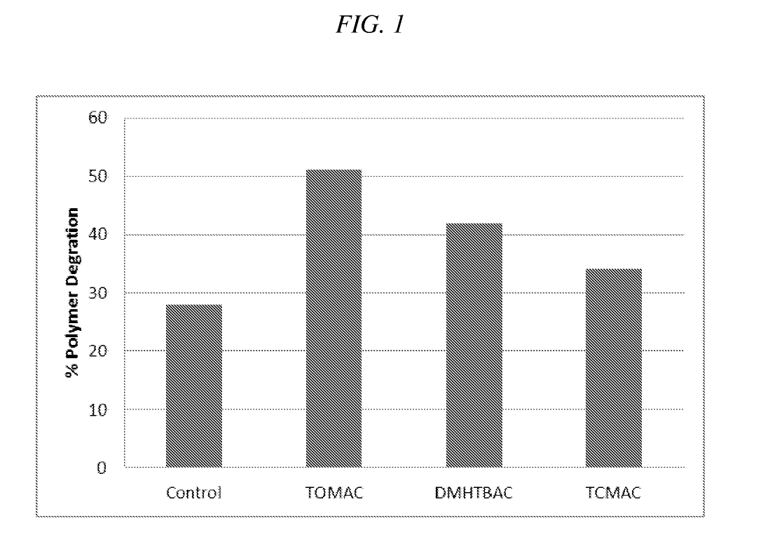

The properties of a diverting material comprising a degradable polymer were investigated. More specifically, the degradation of PLA at a constant temperature of 110° F. in the presence of various DAs and PTCs was recorded at 20 h, and the results are displayed in Table 2 and plotted in FIG. 1. For each sample in Table 2, a 10 g solution was made by mixing 1 g of PLA flakes with either a 1% NaOH solution or a 4% NaOH solution. The PLA flakes were of about 1 mm thickness and of irregular shapes with lengths ranging from 2 mm to 6 mm. Three different PTCs were used as noted in Table 2, TOMAC, DMHTBAC and TCMAC. The three different PTCs were chosen based on their different water solubility: at the concentrations used, TOMAC was partially soluble in water, DMHTBAC was completely soluble in water, and TCMAC is essentially insoluble in water. All concentrations in Table 2 are reported as wt. % based on the weight of the solution.

TABLE 2

| | Residual Polymer Weight [g] |
|---|---|
| Degradation Accelerator | 20 h |
| 4% NaOH | 0.72 |
| 4% NaOH + TOMAC (1%) | 0.49 |
| 4% NaOH + DMHTBAC (1%) | 0.58 |
| 4% NaOH + TCMAC (1%) | 0.66 |
| 1% NaOH | 0.93 |
| 1% NaOH + TOMAC (0.5%) | 0.86 |
| 1% NaOH + DMHTBAC (0.5%) | 0.85 |
| 1% NaOH + DMHTBAC (1%) | 0.86 |
| 1% NaOH + TCMAC (1%) | 0.96 |

In the presence of a 1% NaOH solution, TOMAC and DMHTBAC led to a slightly increased degradation of PLA, from about 7% degradation in the presence of 1% NaOH solution only, to 14-15% degradation when TOMAC or DMHTBAC were added. When TCMAC was added to the 1% NaOH solution, there was arguably no effect in the degradation of the PLA.

The 4% NaOH solution was more effective than the 1% NaOH solution in breaking down PLA: there was about 28% degradation in the presence of the 4% NaOH solution, versus about 7% degradation in the presence of 1% NaOH solution. When a PTC (1%) was added to the 4% NaOH solution, the degradation of PLA was accelerated in comparison to the degradation of PLA in a 4% NaOH solution alone, and the data are displayed in FIG. 1. In the presence of TOMAC, PLA degraded about 51% in 20 h, and the degradation was lower (about 42%) in the presence of DMHTBAC, and also lower (about 34%) in the presence of TCMAC. The presence of TOMAC, DMHTBAC or TCMAC in a 4% NaOH solution enhanced the degradation of PLA.

The following are additional enumerated embodiments of the concepts disclosed herein.

A first embodiment which is a method of servicing a wellbore in a subterranean formation comprising placing a first wellbore servicing fluid comprising a diverter material into a wellbore; allowing the diverter material to form a diverter plug at a first location in the wellbore or subterranean formation; diverting the flow of a second wellbore servicing fluid to a second location in the wellbore or subterranean formation; and contacting the diverter plug with a third wellbore servicing fluid comprising a degradation accelerator and a phase transfer catalyst under conditions sufficient to form one or more degradation products.

A second embodiment which is the method of the first embodiment wherein the diverting material comprises polyesters

A third embodiment which is the method of the second embodiment where the polyesters comprise poly(lactides); poly(glycolides); polyethyleneterephthalates (PETE); polybutyleneterephthalates; polyethylenenaphthalenates, copolymers, blends, derivatives, or combinations thereof.

A fourth embodiment which is the method of any of the first through third embodiments wherein the diverting material comprises polylactic acid.

A fifth embodiment which is the method of any of the first through fourth embodiments wherein the diverting material comprises a polymer having monomeric units characterized by Formula III:

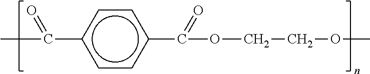

where n has a value ranging from about 50 to about 500.

A sixth embodiment which is the method of any of the first through fifth embodiments wherein the diverting material comprises PETE.

A seventh embodiment which is the method of any of the first through sixth embodiments wherein the diverting material comprises recycled PETE.

An eighth embodiment which is the method of any of the first through seventh embodiments wherein the diverting material comprises a plasticizer.

A ninth embodiment which is the method of any of the first through eighth embodiments wherein the degradation accelerator comprises a base.

A tenth embodiment which is the method of the ninth embodiment wherein the base comprises NaOH, NH₄OH, KOH, LiOH, and Mg(OH)₂, Na₂CO₃, K₂CO₃, NaHCO₃, KHCO₃, BaO, SrO, Li₂O, CaO, Na₂O, K₂O, MgO, Na₃PO₄, Ca₃(PO₄)₂, CaHPO₄, Na₂S, CaS, SrS, sodium silicate, potassium silicate, sodium metasilicate, sodium aluminate, calcium aluminate, or combinations thereof.

An eleventh embodiment which is the method of any of the ninth through tenth embodiments wherein the base comprises NaOH, KOH or combinations thereof.

A twelfth embodiment which is the method of any of the first through eleventh embodiments wherein the phase transfer catalyst comprises a compound that (i) is water dispersible; (ii) has a water solubility less than about 5 wt. %, (iii) has a logarithmic octanol-water distribution coefficient, Log D_{OW}, greater than about 1; and/or (iv) has a hydrophilic-lipophilic balance (HLB) ratio of from about 7 to about 11.

A thirteenth embodiment which is the method of any of the first through twelfth embodiments wherein the phase transfer catalyst comprises a quaternary ammonium salt; a quaternary phosphonium salt, a quaternary arsonium compound, an alkyl pyridinium salt, or combinations thereof.

A fourteenth embodiment which is the method of the thirteenth embodiment wherein the quaternary ammonium salt comprises trioctylmethylammonium chloride (TOMAC), tri(decyl)methylammonium chloride, tricetylmethylammonium chloride (TCMAC), dimethyl(hydrogenatedtallow)benzyl ammonium chloride (DMHTBAC), di(dodecyl)benzylmethylammonium chloride, tetraheptylammonium chloride, di(cetyl)dimethylammonium chloride, tri(decyl)benzylammonium chloride or combinations thereof.

A fifteenth embodiment which is the method of any of the first through fourteenth embodiments wherein the diverter material is present in the wellbore servicing fluid in an amount of from about 1 lb/1000 gal to about 1000 lb/1000 gal.

A sixteenth embodiment which is the method of any of the first through fifteenth embodiments wherein the third wellbore servicing fluid comprises a degradation accelerator in an amount of from about 0.5 wt. % to about 20 wt. % and a phase transfer catalyst in an amount of from about 0.001 wt. % to about 2 wt. % based on the total weight of the wellbore servicing fluid.

A seventeenth embodiment which is the method of any of the first through sixteenth embodiments wherein the second wellbore servicing fluid is a fracturing fluid.

An eighteenth embodiment which is the method of any of the first through seventeenth embodiments wherein the one or more degradation products are water-soluble.

A nineteenth embodiment which is the method of any of the first through eighteenth embodiments further comprising recovering the one or more degradation products and contacting the recovered degradation products with an acidic solution.

A twentieth embodiment which is a method comprising providing first wellbore servicing fluid comprising a degradable diverter material and a phase transfer catalyst; placing downhole the first wellbore servicing fluid; and placing downhole a second wellbore servicing fluid comprising a degradation accelerator.

A twenty-first embodiment which is the method of the twentieth embodiment wherein the degradable diverter material and phase transfer catalyst are precontacted to form a composite material.

A twenty-second embodiment which is a wellbore servicing fluid system comprising a first wellbore servicing fluid comprising a diverter material, wherein the diverter material comprises recycled polyethyleneterephthalate; and a second wellbore servicing fluid comprising a degradation accelerator and a phase transfer catalyst, wherein the degradation accelerator comprises sodium hydroxide.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of servicing a wellbore in a subterranean formation comprising:
placing a first wellbore servicing fluid comprising a diverter material into a wellbore;
allowing the diverter material to form a diverter plug at a first location in the wellbore or subterranean formation;
diverting the flow of a second wellbore servicing fluid to a second location in the wellbore or subterranean formation; and
contacting the diverter plug with a third wellbore servicing fluid comprising a degradation accelerator and a phase transfer catalyst under conditions sufficient to form one or more degradation products.

2. The method of claim 1 wherein the diverting material comprises polyesters.

3. The method of claim 2 where the polyesters comprise poly(lactides); poly(glycolides); polyethyleneterephthalates (PETE); polybutyleneterephthalates; polyethylenenaphthalenates, copolymers, blends, derivatives, or combinations thereof.

4. The method of claim 1 wherein the diverting material comprises polylactic acid.

5. The method of claim 1 wherein the diverting material comprises a polymer having monomeric units characterized by Formula III: 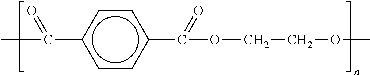
where n has a value ranging from about 50 to about 500.

6. The method of claim 1 wherein the diverting material comprises PETE.

7. The method of claim 1 wherein the diverting material comprises recycled PETE.

8. The method of claim 1 wherein the diverting material comprises a plasticizer.

9. The method of claim 1 wherein the degradation accelerator comprises a base.

10. The method of claim 9 wherein the base comprises NaOH, NH₄OH, KOH, LiOH, and Mg(OH)₂, Na₂CO₃, K₂CO₃, NaHCO₃, KHCO₃, BaO, SrO, Li₂O, CaO, Na₂O, K₂O, MgO, Na₃PO₄, Ca₃(PO₄)₂, CaHPO₄, Na₂S, CaS, SrS, sodium silicate, potassium silicate, sodium metasilicate, sodium aluminate, calcium aluminate, or combinations thereof.

11. The method of claim 9 wherein the base comprises NaOH, KOH or combinations thereof.

12. The method of claim 1 wherein the phase transfer catalyst comprises a compound that (i) is water dispersible; (ii) has a water solubility less than about 5 wt. %, (iii) has a logarithmic octanol-water distribution coefficient, Log D_{OW}, greater than about 1; and/or (iv) has a hydrophilic-lipophilic balance (HLB) ratio of from about 7 to about 11.

13. The method of claim 1 wherein the phase transfer catalyst comprises a quaternary ammonium salt; a quaternary phosphonium salt, a quaternary arsonium compound, an alkyl pyridinium salt, or combinations thereof.

14. The method of claim 13 wherein the quaternary ammonium salt comprises trioctylmethylammonium chloride (TOMAC), tri(decyl)methylammonium chloride, tricetylmethylammonium chloride (TCMAC), dimethyl(hydrogenatedtallow)benzyl ammonium chloride (DMHTBAC), di(dodecyl)benzylmethylammonium chloride, tetraheptylammonium chloride, di(cetyl)dimethylammonium chloride, tri(decyl)benzylammonium chloride or combinations thereof.

15. The method of claim 1 wherein the diverter material is present in the wellbore servicing fluid in an amount of from about 1 lb/1000 gal to about 1000 lb/1000 gal.

16. The method of claim 1 wherein the third wellbore servicing fluid comprises a degradation accelerator in an amount of from about 0.5 wt. % to about 20 wt. % and a phase transfer catalyst in an amount of from about 0.001 wt. % to about 2 wt. % based on the total weight of the wellbore servicing fluid.

17. The method of claim 1 wherein the second wellbore servicing fluid is a fracturing fluid.

18. The method of claim 1 wherein the one or more degradation products are water-soluble.

19. The method of claim 1 further comprising recovering the one or more degradation products and contacting the recovered degradation products with an acidic solution.

20. A method comprising:
providing first wellbore servicing fluid comprising a degradable diverter material and a phase transfer catalyst;
placing downhole the first wellbore servicing fluid; and
placing downhole a second wellbore servicing fluid comprising a degradation accelerator.

21. The method of claim 20 wherein the degradable diverter material and phase transfer catalyst are precontacted to form a composite material.

22. A wellbore servicing fluid system comprising:
a first wellbore servicing fluid comprising a diverter material, wherein the diverter material comprises recycled polyethyleneterephthalate; and
a second wellbore servicing fluid comprising a degradation accelerator and a phase transfer catalyst, wherein the degradation accelerator comprises sodium hydroxide.
